(19) United States
(12) Patent Application Publication
(10) Pub. No.: US 2006/0245482 A1
(43) Pub. Date: Nov. 2, 2006

(54) Time-slot sequenced multi-band uwb communication system

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Briarcliff Manor, NY (US)

(21) Appl. No.: 10/546,945

(22) PCT Filed: Feb. 23, 2004
(86) PCT No.: PCT/IB04/00490

§ 371 Date: Aug. 25, 2005

Related U.S. Application Data
(60) Provisional application No. 60/450,392, filed on Feb. 26, 2003.
(60) Provisional application No. 60/478,806, filed on Jun. 16, 2003.

(51) Int. Cl. H04L 5/16

(52) U.S. Cl. 375/219

(57) ABSTRACT

A system and method for transmission and receipt of multi-band communication according to their time slot sequence includes at a transmitting end: an encoder for encoding data according to a time slot position (s1, s2, s3, s4) for each frequency band; an RF modulator for modulating encoded data over a predetermined plurality of frequency bands (f4, f3, f2, f1) selected from a plurality of frequency bands (f1, fn). The predetermined plurality of frequency bands are independent of each other and an order of transmission of the predetermined plurality of frequency bands being irrelevant, unlike the dependency in spectral keying. The present invention frees up the order of the frequency bands being transmitted, so that they can be used for channelization, security or other purposes and requires less complicated circuitry at the receiver end.

The present invention relates to communication in wireless area networks. More particularly, the present invention relates to modulation schemes in Ultra-Wide-Band communications.

Ultra-wide-band (UWB) is being studied as the next technology for wireless communications, especially for short range communications. There are a number of modulation schemes used to modulate information over a wideband width RF channel. Among them is spectral keying, which is basically a multi-band modulation scheme, where information is carried through the sequence of frequencies transmitted in time.

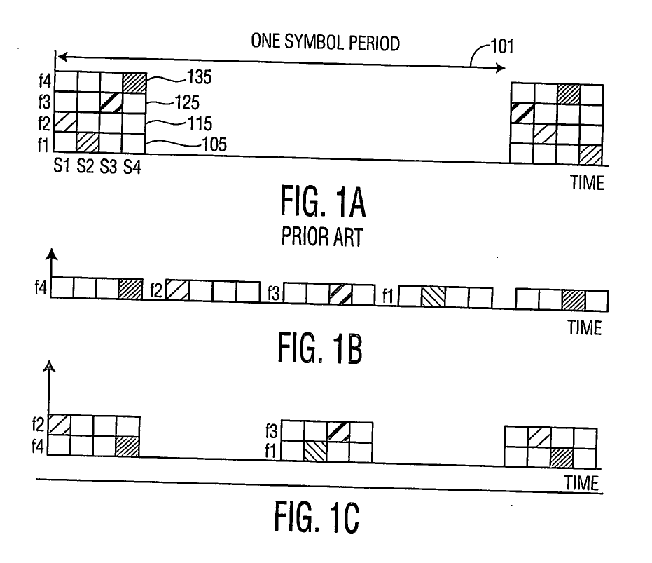

FIG. 1A illustrates an example of a prior art method using the broadcast of a succession of frequencies, such as in spectral keying. In this particular example, there are four frequency bands, labeled 105,115,125 and 135, respectively in a first period 101. In this particular case, all of the pulses are grouped together and are sent as f2, then f1, then f3, then f4. The sequence in the subsequent symbol period is f3, f2, f4, f1. Each of the frequencies has a series of slots s1 through s4. The order of transmission is critical, as the order is part of the spectral keying system used to encode/decode the information.

In the above case, there is a need to use a plurality of parallel receivers at the receiving end, one for each band. As the number of bands are increased, so is the complexity of the receiver.

Accordingly, the present invention provides a method and a system for modulation that while dramatically reducing receiver complexity, achieves the same or better coding performance as that of prior art systems, such as spectral keying. The present invention permits the transmission of frequencies in any order, providing more flexibility than systems using successive frequency bands.

FIG. 1A illustrates a prior art transmission scheme using spectral shift keying.

FIG. 1B illustrates a first aspect of transmission according to the present invention.

FIG. 1C illustrates another variation of the first aspect of the present invention.

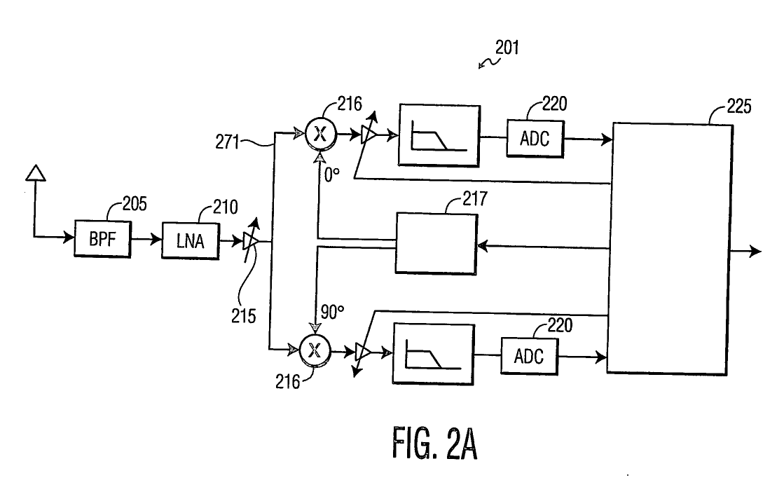

FIG. 2A illustrates a typical receiver used for receipt of multi-band communication.

FIG. 2B illustrates a block diagram of a receiver used for receipt of single band communication in a sequential order.

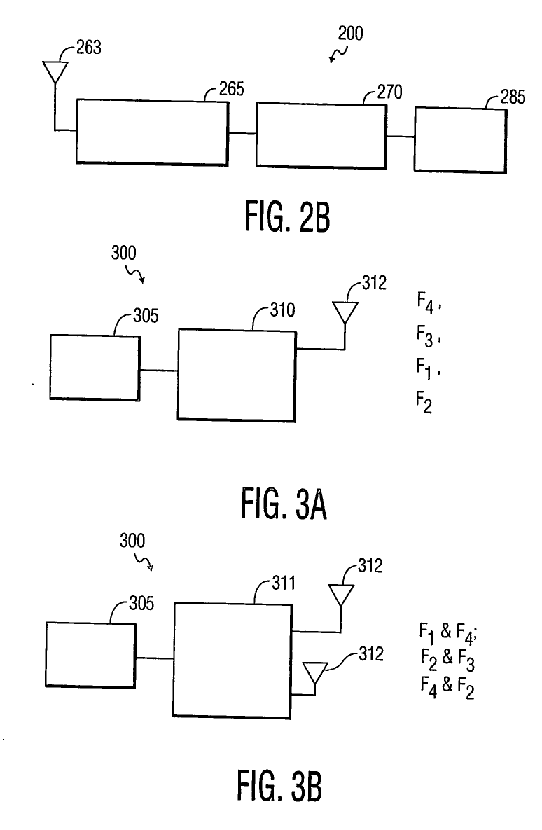

FIGS. 3A and 3B illustrate block diagrams of single band transmitters and multi-band transmitters.

FIGS. 1B and 1C illustrate a first embodiment of a method of transmitting according to the present invention. The first step encodes the same data shown in FIG. 1A, but when the transmission occurs, the sequence of the transmission of frequency is irrelevant.

As shown in FIG. 1B, only one frequency (f4, or f2, f3 or f1) is transmitted at a time. This particular choice of sequence is arbitrary, and the particular transmission sequence of the respective frequencies does not carry information, as is the case with a spectral frequency system know heretofore.

However, according to the present invention, the relative positions of the four slots (s1 through s4) determine the information.

In other words, at the transmission end, a method according to the present invention comprises the steps of:

(a) encoding information in a series of time slots in a plurality of frequency bands; and

(b) modulating pulses over the plurality of frequency bands one band at a time, wherein information encoded in each respective frequency band of the plurality of frequency bands is independent of a sequence of a transmission order of the plurality of frequency bands.

At the receiver end, the method involves the steps of:

(c) demodulating the pulses received from each of the respective bands; and

(d) decoding information from the pulses demodulated in step (c) according to a position of data in time slots for each respective frequency band.

The independence of the sequence of the transmission of the frequency bands is permissible because unlike spectral keying, the order of the frequency transmission is not used as a form of communication. Thus, it is possible to use spectral keying functions except for the encoding and decoding of data according to an order of the transmission of the plurality of frequency bands.

FIG. 1C illustrates another aspect of the present invention, wherein two frequencies (f2, f4 or f3, f1) are transmitted as groups.

As shown in FIG. 1C, first frequencies f2 and f4 are transmitted, followed by f1,f3. The actual choice of the sequence of transmission is arbitrary.

With regard to the actual transmission, it should be noted that each pulse can be modulated using BPSK, QPSK, OFDM, PPM or any other modulation scheme. Thus, the encoder may encode the frequency bands according to two or more modulation schemes. Of course, the receiver will require the capability to demodulate the two or more modulation schemes.

FIG. 2 shows an aspect of the invention, wherein an apparatus performs transmission according to the presently disclosed method. This receiver is suitable for the grouping of frequencies of two that are being transmitted as a group.

The receiver shown in FIG. 2A includes a band-pass filter 205, low noise amplifier 210, a buffer 215, mixers 216, a bank of VCO's 217, analog to digital converters 220. The receiver needs to know what frequency is being received in a given time window. However, this information can be provided rather easily. It is to be stressed that with this proposed receiver, the actual time of the sequence of transmission of frequencies is irrelevant, which is distinguishable from transmission schemes such as spectral keying.

FIG. 2B shows a block diagram of a single band receiver, with a single-band variable tuner 265 have an antenna 263, an RF demodulator 270, followed by a decoder 285. The decoder decodes each of the bands according to the time slot order data in each band, and does not utilize the spectral order of the transmitted bands for decoding information, as no data has been encoded in this fashion at the transmission end.

FIGS. 3A and 3B illustrate two different transmitters that can be used with the present invention. It should be understood by persons of ordinary skill in the art that are many modifications that can be made to the examples that would not depart from the spirit of the invention or the scope of the appended claims, and these examples are provided for purposes of illustration and for limitation to the elements shown.

FIG. 3A shows an encoder 305. The encoder will encode data according to relative time slot position for each respective band to be transmitted, but will not encode data according to a sequence of transmission of the frequency bands. The RF modulator 310 in this case only needs to be a tunable single-band transmitter, and frequency patterns, such as those shown in FIG. 1B, will be transmitted sequentially. For example, f4, followed by f3, followed by f1, followed by f2.

A tunable single band receiver can demodulate and decode the different bands.

FIG. 3B shows the encoder 305, but the RF modulator 311 has the capability of transmitting a plurality of bands (also referred to as groups of bands). For example, f1 and f4 can be transmitted as one group; f2 and f3 as a second group; f4 and f2 as another group. Again, this illustration is shown for illustrative purposes and in no way is the present invention limited to transmitting groups of two frequency bands. Three or more frequency bands (as many as desired) can be transmitted. What must be understood is the number of multi-bands simultaneously transmitted increases the complexity required of the receiver. Also, in the present invention, the sequence of transmission of the frequency bands is irrelevant, and no information is encoded according to the order of transmission. Thus the bands may be transmitted in groups that are more efficient than a sequential order.

An advantage of the present invention is that because the actual sequence of frequency band transmission is not used a means to encode/store information, the actual sequence of transmission is available for uses such as channelization or security where each receiver has a unique sequence of transmitted waveforms. For example, one transmitter may sequence f1, f2, f3, f4 and the other as f1, f2, f4, f2. It is understood by persons of ordinary skill in the art that various modifications and substitutions may be made to the descriptions of the present invention that do not depart from the spirit of the invention and the scope of the appended claims. For example, the number of bands used, the type of modulation, the frequency of the bands, the number of frequency bands transmitted, the encoding schemes can all be varied according to need. In fact the transmission of the bands may overlap and still be considered a multi-band communication.

1. A transmitter 300 for transmitting time-slot sequenced multi-band communication, comprising:
an encoder (305) for encoding data according to a time slot position (s1, s2, s3,s4) for each frequency band;
an RF modulator (310) for modulating encoded data over a predetermined plurality of frequency bands (f4, f3, f2, f1) selected from a plurality of frequency bands (f1, . . . fn), said predetermined plurality of frequency bands being independent of each other and an order of transmission of the predetermined plurality of frequency bands being irrelevant; and
an antenna 312 where at least two respective frequency selected from the plurality of frequency bands are transmitted.

2. The transmitter 300 according to claim 1, wherein the transmitter transmits the modulated frequency bands sequentially.

3. The transmitter 300 according to claim 1, wherein the transmitter transmits the modulated frequency bands simultaneously.

4. The transmitter 300 according to claim 1, wherein the transmission of the modulated frequency bands overlap.

5. The transmitter 300 according to claim 1, wherein the encoder 305 encodes data according to a spectral keying method except that said coding is independent of an order of transmission of the plurality of frequency bands.

6. The transmitter 301 according to claim 1, wherein the plurality of frequency bands are transmitted over ultra-wide-band frequencies.

7. The transmitter 301 according to claim 1, wherein the encoder 305 is adapted for encoding the frequency bands according to multiple modulation schemes, with each frequency band being encoded according to a predetermined modulation scheme.

8. The transmitter according to claim 7, wherein the encoder 305 is adapted to encode in two or more of BPSK, SPSK, OFDM, and PPM.

9. A receiver 200 for receiving time-slot sequenced multi-band communication that is transmitted sequentially, comprising:
a tuner (265) having variable frequencies to be tuned for receiving sequentially a plurality of bands of the time-slot sequenced multi-band communication that are transmitted;
a RF demodulator (270)for demodulating the frequency band received by the tuner (265); and
a decoder (285) for decoding the frequency bands independently of each other and of an order in which the frequency bands were received.

10. The receiver according to claim 9, wherein the frequency bands (f4, f3, f2, f1) of the communication received are ultra-wide-band frequencies.

11. The receiver according to claim 9, wherein the demodulator 271 is adapted for demodulation of the frequency bands according to multiple modulation schemes, with each frequency band being demodulated according to a predetermined modulation scheme.

12. The receiver according to claim 9, wherein the demodulator 270 is adapted to demodulate the transmission of multiple frequency bands demodulated in a predetermined plurality of modulation schemes, said schemes comprising modulation in two or more of BPSK, SPSK, OFDM, and PPM.

13. A receiver 201 for receiving time-slot sequenced multi-band communication that is transmitted at least partially simultaneously for two or more frequency bands, comprising:
a tuner 205 for receiving a signal containing more than one frequency band (f1, f2, f3, f4);
an RF demodulator 271 comprising mixers 216 for demodulating the different frequency bands into respective individual frequency bands; and
a decoder (220, 225) for independently decoding the different frequency bands irrespective of an order of their transmission, each frequency band being decoded according to a position of information in a time-slot arrangement.

14. The receiver according to claim 13, wherein the frequency bands (f4, f3, f2, f1) of the communication received are ultra-wide-band frequencies.

15. The receiver according to claim 13, wherein the demodulator 270 is adapted for demodulating the frequency bands according to multiple modulation schemes, with each frequency band being modulated according to a predetermined modulation scheme.

16. The receiver according to claim 13, wherein the demodulator 270 is adapted to demodulate the transmission of multiple frequency bands encoded in a predetermined plurality of modulation schemes, said schemes comprising modulation in two or more of BPSK, SPSK, OFDM, and PPM.

17. A system for transmission and receipt of multi-band communication according to their time slot sequence comprising:
at a transmitting end 300,301:
an encoder (305) for encoding data according to a time slot position (s1, s2, s3,s4) for each frequency band;
an RF modulator (310) for modulating encoded data over a predetermined plurality of frequency bands (f4, f3, f2, f1) selected from a plurality of frequency bands (f1, . . . fn), said predetermined plurality of frequency bands being independent of each other and an order of transmission of the predetermined plurality of frequency bands being irrelevant; and
an antenna 312 where at least two respective frequency selected from the plurality of frequency bands are transmitted;
at a receiving end 200,201:
a tuner (265) having variable frequencies to be tuned for receiving sequentially a plurality of bands of the time-slot sequenced multi-band communication that are transmitted;
a RF demodulator (270)for demodulating the frequency band received by the tuner (265); and
a decoder (285) for decoding the frequency bands independently of each other and of an order in which the frequency bands were received.

18. The system according to claim 17, wherein the transmitter 300 transmits the modulated frequency bands sequentially.

19. The system according to claim 17, wherein the transmitter 301 transmits the modulated frequency bands simultaneously.

20. The system according to claim 17, wherein the transmitter 201 overlaps transmission of the modulated frequency bands.

21. The system according to claim 17, wherein the encoder 305 is adapted for encoding the frequency bands according to multiple modulation schemes, with each frequency band being encoded according to a predetermined modulation scheme.

22. The system according to claim 17, wherein the encoder 305 is adapted to encode in two or more of BPSK, SPSK, OFDM, and PPM.

23. A method for time-slot sequenced multi-band communication, comprising the steps of:
(a) encoding information in a series of time slots in a plurality of frequency bands;
(b) modulating pulses over the plurality of frequency bands one band at a time, wherein information encoded in each respective frequency band of the plurality of frequency bands is independent of a sequence of a transmission order of the plurality of frequency bands.

24. The method according to claim 23, further comprising:
(c) demodulating the pulses received from each of the respective bands; and
(d) decoding information from the pulses demodulated in step (c) according to a position of data in time slots for each respective frequency band.

25. The method according to claim 23, wherein the frequency of the plurality of bands comprises ultra-wide band frequency.

26. The method according to claim 24, wherein the demodulation of pulses in step (c) is performed using a tunable single-band receiver for the plurality of frequency bands transmitted sequentially.

27. The method according to claim 23, wherein the encoding in step (a) and the decoding in step (d) utilizes spectral keying without transmitting information according to a sequence of a transmission order of the plurality of frequency bands.

28. The method according to claim 23, wherein the frequency bands in step (b) are transmitted two at a time.

29. The method according to claim 23, wherein the frequency bands in step (b) are transmitted in groups of three or more bands.

30. The method according to claim 23, wherein the frequency bands in step (b) are transmitted in groups of two or more bands.

31. The method according to claim 24, wherein the demodulation of pulses in step (c) is performed using a tunable multi-band band receiver commensurate with a number of frequency bands being transmitted as a group.

32. The method according to claim 23, wherein the encoder is adapted for encoding the frequency bands according to multiple modulation schemes, with each frequency band being encoding according to a predetermined modulation scheme.

33. The method according to claim 23, wherein the encoder 305 is adapted to encode in two or more of BPSK, SPSK, OFDM, and PPM.

34. The method according to claim 24, wherein the demodulating step (c) is adapted for demodulating the frequency bands according to multiple modulation schemes, with each frequency band being modulated according to a predetermined modulation scheme.

35. The method according to claim 24, wherein the demodulating step (c) is adapted to demodulate the transmission of multiple frequency bands encoded in a predetermined plurality of modulation schemes, said schemes comprising modulation in two or more of BPSK, SPSK, OFDM, PPM.
